(19) United States
(12) Patent Application Publication
(10) Pub. No.: US 2017/0323050 A1
(43) Pub. Date: Nov. 9, 2017

(54) STRUCTURAL ANALYSIS OF PROTEINS BY STRUCTURAL REPRESENTATION AND COMPARISON OF PROTEINS

(71) Applicant: CARMEL-HAIFA UNIVERSITY ECONOMIC CORPORATION LTD., Haifa (IL)

(72) Inventors: Inbal Tal, Haifa (IL); Yuval Nov, Kiryat Tivon (IL); Rachel Kolodny, Kiryat Tivon (IL)

(73) Assignee: CARMEL-HAIFA UNIVERSITY ECONOMIC CORPORATION LTD., Haifa (IL)

(21) Appl. No.: 15/630,503

(22) Filed: Jun. 22, 2017

Related U.S. Application Data
(63) Continuation of application No. 13/394,948, filed on Mar. 8, 2012, now abandoned.
(60) Provisional application No. 61/241,161, filed on Sep. 10, 2009.

(51) Int. Cl. G06F 19/16

(52) U.S. Cl. CPC G06F 19/16

(57) ABSTRACT

The present invention is directed to systems and methods for fast and accurate structural representation and comparison of proteins. Specifically, the present invention provides a method for retrieval of a candidate set of near structural neighbors or structurally similar proteins of a query protein. The method is based on a representation of a protein structure as a “bag of words”—a collection of small disjoint backbone protein fragments. The representation allows quick comparison procedures of the query protein structure to a large number of known protein structures obtained for example, from a repository or database of proteins.

### CROSS REFERENCE TO RELATED APPLICATIONS

This application is a continuation of U.S. patent application Ser. No. 13/394,948, which was filed Mar. 8, 2012, which is a 35 USC §371 national stage application of PCT/IL2010/000742 and was filed Sep. 7, 2010 and claims priority to U.S. Provisional Patent Application No. 61/241,161, filed Sep. 10, 2009, all of which are incorporated herein by reference as if fully set forth.

### FIELD

This invention relates to the field of bioinformatics. In particular the present invention relates to methods and systems aimed at structural comparison of proteins.

### BACKGROUND

Finding structural neighbors of a protein, namely identifying proteins that share a significant portion of their substructures, in the complete PDB (Protein Data Bank) is a challenging task.

Structural alignment quantifies the similarity between two protein structures by identifying geometrically similar substructures.

Unfortunately, structurally aligning two structures is an expensive computation. Consequently, the computation costs for naively using structural alignment to compare a (new) query structure to all structures in the PDB, or structurally aligning all-against-all PDB structures, is prohibitively expensive.

To search the complete PDB significantly faster, researchers devised the ‘filter-and-refine’ paradigm [1],[2]. A filter method quickly sifts through a large set of structures and identifies a small candidate set to be aligned by a reliable, yet computationally expensive, structural alignment method.

PRIDE represents a protein structure by the distributions of the distances between Cα atoms, and measures the similarity of two structures by comparison between distributions of inter-residue distances [3]. Zotenko et al. represents a protein structure by a vector of the frequencies of patterns of secondary structure element (SSE) triplets [4]. Several methods (e.g., [5], [6], [7], [8], [9]) describe a structure by spatially ordered string consisting of a limited set of structural alphabet letters, and sequence-align these strings to measure structural similarity.

### REFERENCES

1. Aung, Z. and K. L. Tan, Rapid retrieval of protein structures from databases. Drug Discov Today, 2007. 12(17-18): p. 732-9.
2. Carugo, O., Rapid Methods for Comparing Protein Structures and Scanning Structure Databases. Current Bioinformatics, 2006. 1: p. 75-83.
3. Carugo, O. and S. Pongor, Protein fold similarity estimated by a probabilistic approach based on C(alpha)-C(alpha) distance comparison. J Mol Biol, 2002. [0010] 315(4): p. 887-98.
4. Zotenko, E., D. P. O'Leary, and T. M. Przytycka, Secondary structure spatial conformation footprint: a novel method for fast protein structure comparison and classification. BMC Struct Biol, 2006. 6: p. 12.
5. Friedberg, I., et al., Using an alignment of fragment strings for comparing protein structures. Bioinformatics, 2007. 23(2): p. e219-24.
6. Tung, C. H., J. W. Huang, and J. M. Yang, Kappa-alpha plot derived structural alphabet and BLOSUM-like substitution matrix for rapid search of protein structure database. Genome Biol, 2007. 8(3): p. R31.
7. Chang, P. L., A. W. Rinne, and T. G. Dewey, Structure alignment based on coding of local geometric measures. BMC Bioinformatics, 2006. 7: p. 346.
8. Gao, F. and M. J. Zaki, PSIST: indexing protein structures using suffix trees. Proc IEEE Comput Syst Bioinform Conf, 2005: p. 212-22.
9. Guyon, F., et al., SA-Search: a web tool for protein structure mining based on a Structural Alphabet. Nucleic Acids Res, 2004. 32 (Web Server issue): p. W545-8.
10. Kolodny, R., et at, Small libraries of protein fragments model native protein structures accurately. J Mol Biol, 2002. 323(2): p. 297-307.
11. Kolodny, R., P. Koehl, and M. Levitt, Comprehensive Evaluation of Protein Structure Alignment Methods: Scoring by Geometric Measures. Journal of Molecular Biology, 2005. 346(4): p. 1173-1188.
12. Taylor, W. R. and C. A. Orengo, Protein structure alignment. J Mol Biol, 1989. 208(1): p. 1-22.
13. Holm, L. and C. Sander, Protein structure comparison by alignment of distance matrices. J Mol Biol, 1993. 233(1): p. 123-38.
14. Kleywegt, G. J., Use of non-crystallographic symmetry in protein structure refinement. Acta Crystallogr D Biol Crystallogr, 1996. 52(Pt 4): p. 842-57.
15. Tatusova, T. A. and T. L. Madden, BLAST 2 Sequences, a new tool for comparing protein and nucleotide sequences. FEMS Microbiol Lett, 1999. 174(2): p. 247-50.
16. Gribskov, M. and N. L. Robinson, The use of receiver operating characteristic (ROC) analysis to evaluate sequence matching. Computers & Chemistry, 1996. 20(1): p. 25-343.
17. Miller, R. G. J., Simultaneous Statistical Inference, 2nd edition. 1981.
18. Benjamini, Y. and Y. Hochberg, Controlling the False Discovery Rate: A Practical and Powerful Approach to Multiple Testing. Journal of the Royal Statistical Society. Series B (Methodological), 1995. 57(1): p. 300.
19. Good, P., Permutation Tests (2nd ed.). 2000.

### SUMMARY

The present invention is directed to systems and methods for fast and accurate structural representation and comparison of proteins. Specifically, the present invention provides a method for retrieval of a candidate set of near structural neighbors or structurally similar proteins of a query protein. The method is based on a representation of a protein structure as a “bag of words” (or a “bag of fragments”)—a collection of small disjoint backbone protein fragments. The inventors utilize these protein backbone fragments as disjoint bins or buckets for analysis. The analysis provides a bag of words representation which maintains a measure of the occurrences or observation frequencies of specific protein backbone fragments in the protein structure, e.g., the bag of words can be in the form of a vector or an array of the observation frequencies. The inventors have found that procedures utilizing such bag of words representation provide accurate protein comparison while substantially increasing performance by inter-alia avoiding computational time arising from alignment or ordering of structural elements of the protein.

The representation allows quick comparison procedures of the query protein structure to a large number of known protein structures obtained for example, from a repository or database of proteins.

Therefore in one aspect, the present invention provides a method for generating a representation for the macromolecular structure of a protein of interest, comprising:

acquiring a first representation of a collection of predetermined, three dimensional structures of disjoint protein backbone fragments;

acquiring a second representation. The second representation comprises the three dimensional structure of a plurality of backbone segments (the term “segment” refers to a fragment, wherein said fragment is in the protein of interest) in the protein of interest;

utilizing a processor to determine the most geometrically similar disjoint protein backbone fragment in said first representation, for each of the backbone segments; and

generating data being the observation frequencies of each most geometrically similar protein backbone fragment in said protein of interest; said data represents the macromolecular structure of the protein of interest.

In another aspect, the present invention provides a method for generating a database representing macromolecular structures of a plurality of proteins, comprising:

acquiring a first representation of a collection of predetermined, three dimensional structures of disjoint protein backbone fragments;

acquiring a second representation. The second representation comprises the three dimensional structure of a plurality of backbone segments in each protein of the plurality of proteins;

utilizing a processor to determine the most geometrically similar backbone fragment in the first representation for each of the backbone segments; and

generating data being the observation frequencies of each of the most geometrically similar protein backbone fragment in each protein of the plurality of proteins; and

for each protein in said plurality of proteins, encoding an array maintaining said data; and optionally storing the array in said database.

In another aspect, the present invention provides a method for retrieval of structurally similar proteins, comprising:

acquiring the database representing the macromolecular structures of a plurality of proteins, as disclosed herein; thereby obtaining a plurality of arrays, each representing a protein of the plurality of proteins;

obtaining a query protein of interest;

acquiring a bag-of-words representation for the macromolecular structure of said protein of interest; thereby obtaining an array having data being the observation frequencies in the protein of interest of each of the most geometrically similar disjoint protein backbone fragment;

utilizing a processor for measuring similarity between the array in the database and the array representing the protein of interest; wherein the measurement approximates structural similarity between the protein of interest and a protein in said plurality of proteins, thereby identifying structurally similar proteins.

In another aspect, the present invention provides a method for constructing an index for three dimensional macromolecular structures of proteins, comprising:

acquiring the database representing the macromolecular structures of a plurality of proteins as disclosed herein, thereby acquiring an array for each protein of the plurality of proteins;

indexing the arrays to allow efficient access to said array.

In another aspect, the present invention provides a system for searching structurally similar proteins, comprising:

remote or local storage utility configured and operable to maintain representations of the three dimensional structure of disjoint protein backbone fragments;

remote or local storage utility configured and operable to maintain the macromolecular structures of a plurality of proteins, each protein is represented by a first array maintaining a measurement of observation frequencies of the disjoint protein backbone fragments in said protein;

an interface module configured to obtain a query protein; the three dimensional structure of a query protein is transformed to obtain a second array representation maintaining a measurement of observation frequencies of the disjoint protein backbone fragments in the query protein;

a comparison module configured and operable to receive the first and second arrays as input and measure similarity between the first and second arrays; the measurement approximates structural similarity between the represented proteins

wherein the comparison module determines the distance between the first and second array representations; thereby identifying structurally similar proteins.

In yet another aspect, the present invention provides a computer readable medium for storing computer instructions which cause a computer to perform any of the above methods.

### BRIEF DESCRIPTION OF THE DRAWINGS

In order to understand the invention and to see how it may be carried out in practice, embodiments will now be described, by way of non-limiting example only, with reference to the accompanying drawings, in which:

FIGS. 1A-1D are a schematic illustration of a protein structure as a fragments bag of words representation and histogram. FIG. 1A represents 6 illustrative protein fragments. FIG. 1B demonstrates the segments in the protein of interest which correspond to each of the fragments illustrated in 1A. FIG. 1C is a bag of words illustration of the protein of interest. FIG. 1D is a histogram representing the bag of words.

FIGS. 2A-2C are graphs showing the average AUC of ROC curves of identifying near structural neighbors. Three definitions of near structural neighbors using SAS threshold values of 2 A (FIG. 2C), 3.5 A (FIG. 2B), and 5 A (FIG. 2A) are used. FIGS. 2A-2C show the performance libraries with fragments of different lengths (6, 7, 9, 10, 11, and 12 residues), and different number of fragments (value along the x-axis), and using the Cosine (plus sign), Euclidean (circles), and histogram intersection (diamonds) distance.

FIGS. 3A-3C are graphical representations of the best library of 400 fragments of length 11 compared to the values of methods developed by other scholars: the sequence-based similarity measure with a fine dashed black line, the filter methods with dashed black lines, and the structure alignment methods with solid black lines. As shown, the best fragments bag-of-words similarity measure performs similarly to CE and STRUCTAL—two computationally expensive and highly trusted structural alignment methods. The graph represents SAS threshold values of 2 A (FIG. 3C), 3.5 A (FIG. 3B), and 5 A (FIG. 3A).

FIGS. 4A-4C are graphs where Cosine (FIG. 4A), Euclidian (FIG. 4B), and Histogram Intersection distances (FIG. 4C) vs. RMSD in structure pairs within NMR assemblies is shown. The data set has 230 NMR assemblies with 43,246 pairs with RMSD≦A [3]. The number of occurrences in each combination of bag-of-words and RMS distances is color-coded reflected by the intensity of the color. The vast majority of the pairs in this set are identified as very similar by our fragments bag-of-words distances.

FIG. 5 is an illustration of representation of a partially specified protein structure based on an internal distance matrix results in a significant amount of missing information. A protein structure that has two (equally sized) domains of known structure is considered. The gray regions denote the domain of known structure. The relative orientation of the two domains is unknown, and hence the white regions in the matrix are unknown. In a representation of this matrix, only half of the matrix patches are from the (gray) known regions.

FIG. 6 is a flow chart schematically illustrating a method for generating a representation for the macromolecular structure of a protein of interest in accordance with one embodiment of the invention.

FIG. 7 is a flow chart schematically illustrating a method for generating a database representing macromolecular structures of a set of proteins in accordance with one embodiment of the invention.

FIG. 8 is a flow chart schematically illustrating a method for retrieval of structurally similar proteins in accordance with one embodiment of the invention.

FIG. 9 is a block diagram schematically illustrating a system for searching structurally similar proteins in accordance with one embodiment of the invention.

### DETAILED DESCRIPTION

### Definitions

As used herein, “bag-of-words”, “bag of fragments”, “BoW”, “FragBag” shall refer to a library, collection, database, or a repository of unordered and disjoint backbone fragments, specifically protein backbone fragments. Particularly, the library may comprise the three dimensional structure of the protein backbone fragments. The terms “bag-of-words” and “bag of fragments” are used herein interchangeably.

In the present context “proteins” include any amino acid based peptide or polypeptide molecule, as well as mutated proteins including proteins having an amino-terminal and/or carboxy-terminal deletions. The protein can be a naturally occurring or an artificial protein including an in silico simulated protein (a decoy protein).

As used herein “fragment” or “protein backbone fragment” refers to a portion of a protein or a peptide. Fragments typically represent a polypeptide of at least 5, 6, 7, 9, 11, 12, 15, or 20 amino acids.

As used herein the term “macromolecular structure” refers to the tertiary and/or quaternary structure of a protein.

As used herein the term “representation” refers to data items representing protein structure. Specifically, the data items of the present invention are representations of the three dimensional structures of the protein fragments or protein backbone fragments. In particular, as used herein the terms “geometric fragments” or “geometrical fragments” refer to a fragment as defined herein-above wherein the data item represents geometric structure or constituent of the protein in a three dimensional coordinate space. For example, a three dimensional coordinate space may be a Euclidean three dimensional coordinate system. The representations can be of a query protein, a preprocessed protein in a database or a repository, or a preprocessed set of proteins. Furthermore, the data item can be implemented as a vector and/or an array, and/or a set of parameters. The data item(s) of the present invention are typically maintained in a repository or a database.

As used herein “disjoint protein backbone fragments” refers to a collection of protein backbone fragments which are disjoint. Each subset of the collection is spatially (or geometrically) unordered and lacks structural order continuity. In this respect, spatial or geometric order with respect to a pair of disjoint protein backbone fragments means relative positions or arrangement of the pair within a coordinate system. Structural continuity means an order of appearance along a protein structure.

By way of non-limiting example, a protein can be represented by the set of disjoint protein backbone fragments denoted as {‘a’, ‘f’, ‘t’‘} which means single occurrence of fragments ‘a’, ‘f’, and ‘t’ in the protein.

As used herein, “protein segment” refers to a data item representing a fragment, as defined above, wherein said fragment is present in the query protein, protein of interest, or a protein in a plurality of proteins of interest. Protein segment is specifically a protein backbone segment. Protein segment shall refer to the geometric structure or three dimensional constituents in a three dimensional coordinate space of the protein backbone segment. In particular, a protein segment encompasses representation of at least 4, 5, 6, 7, 9, 11, 12, 15, or 20 amino acids.

In the present application, the phrases “protein structure” or “fragment structure” refers to the three dimensional structure of a protein or protein fragment.

As used herein “RMSD” shall have its ordinary meaning in bioinformatics and shall refer to root mean square deviation. RMSD is used in the present invention as a distance measure between a library fragment and an overlapping segment in a protein.

“local fit” shall refer to procedure wherein each (overlapping) segment in a protein backbone is approximated by the fragment that is most similar to it in the bag of fragments or collection of protein fragments (in terms of RMSD); the average local-fit RMSD is typically less than 5 A, 4 A, 3 A, 2 A or 1 A.

As used herein the terms “observation frequencies” and “occurrences” are used interchangeably and refer to the number of times a certain fragment appears in a protein. The term further encompasses any value derived thereof, such as standardized or normalized values thereof.

As used herein the phrase “bag-of-words representation” and “bag or fragments representation” are used interchangeably and refer to a data item representing a protein or a protein structure. The bag-of-words representation maintains a measure of occurrences or observation frequencies of specific protein backbone fragments in the protein structure. Thus, the bag-of-words representation can maintain the number of times a certain protein backbone fragment appears or being observed in the protein structure. The appearance (or observation) of specific protein backbone fragments can be determined by comparing segments of the protein structure to protein fragments of bag-of-words library and identifying the most geometrically similar protein backbone fragment to the observed segment.

In some embodiments, the bag of words representation can be in the form of a vector or an array of the occurrences or observation frequencies.

As used herein, “vector” shall be used interchangeably with the term “array” and shall encompass an arrangement of numbers.

As used herein, “database” shall refer to a collection of data organized by set of rules or schema.

An “index” shall mean a database or any other system or utility permitting storage and retrieval of information comprising any associative data structure, array, container, dictionary which allows query-processing therewith. An index typically comprises a collection of keys and a collection of values, where each key is associated with one more value. The operation of finding the value associated with a key is commonly referred to as a lookup, and this is an operation supported by the index disclosed herein. An index also encompasses an inverted index. For example, an inverted index is an index data structure storing a mapping from a protein database, such as protein fragments, to positions in a database file or other I/O utility.

A “query” shall mean a search for information in an index or database. The query can include a query protein (e.g., a representation of the three dimensional structure of the query protein) and the information search can be information indicative of proteins having structural similarity with the query protein.

In the present invention, “query protein” and “protein of interest” are used interchangeably and refer essentially to the protein subjected to the techniques of the present invention.

As used herein, “encoding” shall mean transforming an object (e.g., a protein) or a representation into a different representation. For example, a protein, such as a query protein, represented by an array of coordinates of its three dimensional backbone structure is a form of encoding. By way of non-limiting example, bag of words is an example of encoding.

The present invention provides a method of generating a representation of the macromolecular structure of a protein of interest.

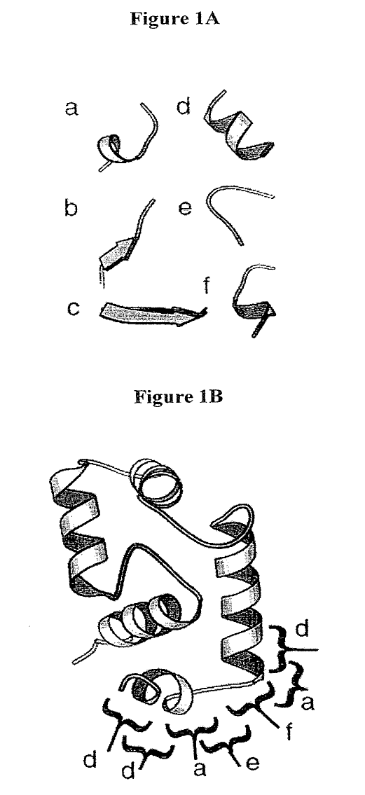

In the bag-of-words representation, in accordance with the present invention, a protein structure is succinctly described by a vector of length N, the size of the fragment library. FIGS. 1A-1D are a non-limiting example illustrating how this vector is calculated or determined from the a-Carbon coordinates of a given protein. For each contiguous (and overlapping) k-residue segment along the protein backbone, a procedure is performed to identify the library fragment of length k that fits it best in terms of RMSD after optimal superposition. The protein is described or represented by a vector of the number of times each library fragment was used. FIG. 1A shows a fragment library of six abstract fragments. In FIG. 1B each (overlapping) contiguous segment in the protein backbone is described by the most similar fragment in the library, and all fragments are collected in a bag-of-words representation which is a set or library of geometric fragments (shown in FIG. 1C); the order of the fragments is not maintained. Thus collection is unordered. The protein structure is then represented in FIG. 1D by a vector that shows for each library fragment, the number of times it occurs in the bag of words. In this example, the vector representation is v=(4, 0, 0, 5, 1, 3).

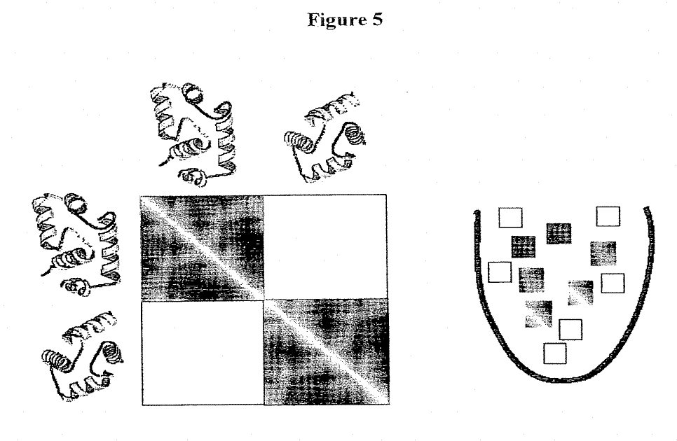

FIG. 6 shows a flow chart describing a method for generating a representation for the macromolecular structure of a protein of interest 600, in accordance with an embodiment of the invention. The method provides a bag-of-fragments (or a bag-of-words) representation of the protein as further detailed herein. The method includes in general the step of acquiring a first representation (such as a data item) of a collection of predetermined, three dimensional structures of disjoint protein backbone fragments. The term acquiring further includes database utility services which can be provided locally or remotely. Database services can also be provided in a computer environment such as but not limited to computer network environments and the like.

The method also includes a procedure for acquiring a second representation. The second representation includes the three dimensional structure of a plurality of backbone segments in the protein of interest. In some embodiments, the three dimensional structure includes the three dimensional structure of a geometric fragment.

A processor is configured and operable to analyze backbone segment for each of the backbone segments of the protein of interest. The analysis determines the most geometrically similar protein backbone fragment in the first representation. In some embodiments all segments of the protein of interest are analyzed to determine the most geometrically similar protein backbone fragment in the first representation. In some embodiments a subset of segments from the protein of interest are analyzed to determine the most geometrically similar protein backbone fragment in the first representation.

The output of the method 600 is processed data, being a representation for the protein of interest. The processed data being the observation frequencies of each most geometrically similar protein backbone fragment in the protein of interest.

The data can be maintained in vector or an array.

The inventors found that the processed data, being a bag-of-fragments (or a bag-of words) representation, can be actually utilized as a representation of the macromolecular structure of the protein of interest. This representation thus allows the performance of protein comparisons without the need to determine the order of the disjoint fragments (or other protein portions) which is required in protein alignment procedures.

Therefore, the method 600 comprises a step of acquiring of data 630. This step comprises reading a first representation of three dimensional constituents or structure of protein fragments 635. Procedure 630 also includes the processing and/or reading of the three dimensional structure of a protein of interest 640. Backbone segments of the protein of interest are obtained. For each of said backbone segment, a processor is utilized for determining the most geometrically similar protein fragment in said first representation, step 660. Optionally, procedure 660 is preceded by an extraction of segments from the protein of interest (or representation thereof). The segments can be backbone segments 665. In some embodiments, the protein of interest or a query protein can be sectioned to segments. By way of non-limiting example, the protein of interest (or a portion thereof) can be divided or sectioned to three dimensional protein segments corresponding to a predetermined length, e.g., 5-20 amino acids. In some embodiment, the protein segments can overlap.

Data is generated, the data being the occurrence or observation frequencies of each most geometrically similar protein fragment in said protein of interest 690. This data being a bag-of-fragments representation which maintains information indicative of unordered and disjoint protein fragments. The data can be maintained in a vector or an array which can be generated or allocated to that end 695.

Determination of the most geometrically similar protein fragment can be performed by a local fit procedure 670 which for geometric fragment includes geometric superimposition of protein fragment vis-a-vis the compared backbone segments of the protein of interest. The more accurate the superimposition the more similar the fragment is.

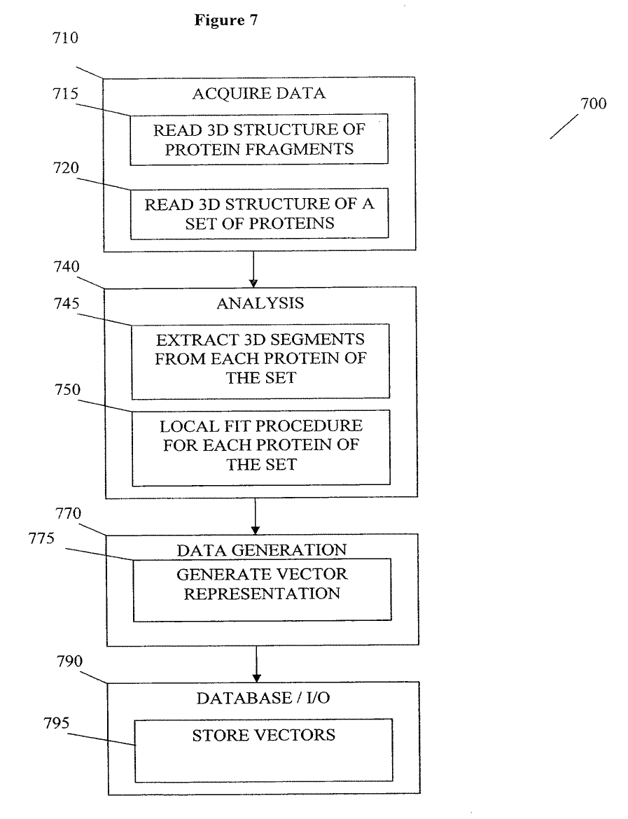

Turning now to FIG. 7, a flow chart is provided describing the method for generating a database to represent structures of a plurality of proteins 700, in accordance with an embodiment of the invention. The method 700 generates a database which can represent structures (e.g., macromolecular structures) of a plurality of proteins. This method includes the acquisition of a first representation of a collection of predetermined three dimensional structures of disjoint protein backbone fragments. As described above, acquisition of data can include a database utility service which can be provided locally, remotely, on the basis of computer network environments and the like. The method 700 further comprises acquiring a second representation. The second representation includes the three dimensional structure of a plurality of backbone segments in each protein of the plurality of proteins.

A processor is configured and operable to determine the most geometrically similar backbone fragment for the backbone segments in the first representation. A bag of fragments representation can be thus generated. The representation being the observation frequencies of each of said most geometrically similar protein backbone fragment in each protein of said plurality of proteins. Any protein in the plurality of proteins can thus be represented, for example by an array (or a paired/corresponding array) which maintains the observation frequencies of each most geometrically similar protein backbone fragments in the protein being represented. Therefore, any (or all) protein(s) in the plurality of proteins can be encoded to an array maintaining said data/bag-of fragments representation. In some embodiments, the array can be stored (e.g., for later retrieval) in said database.

The method thus includes the steps of acquiring data required for the establishment of the database 710. Acquiring data 710 can therefore include the steps of acquiring a first representation of the three dimensional structure of protein fragments 715; acquiring a second representation of the three dimensional structure of a set of proteins 720, the second representation includes the three dimensional structure of each backbone segment in each protein of the set 745. This second representation is used in the analysis procedure 740.

A processor is configured and operable to determine the most geometrically similar fragment to the backbone segments 750 (geometrically similar fragments are maintained in the first representation).

The processor further is operable to generate processed data being the occurrence or observation frequencies of each of the most geometrically similar protein fragments in each protein of the set. The processed data maintains a representation for any protein of the set. The processed data is indicative of the observation frequencies of each most geometrically similar protein backbone fragment to the protein segments of any (or all) protein(s) of the set.

For each protein of the set, the method 700 can further include an encoding/data generation procedure 770 of the data output of the analysis (e.g., the processed data) 740. Therefore, the encoding procedure can include allocating or generating an array maintaining the processed output data 775. The output data of the analysis includes a bag-of-fragments representation.

Method 700 can optionally include I/O procedures 790 which typically further provide storage and retrieval services of the array in the database 795.

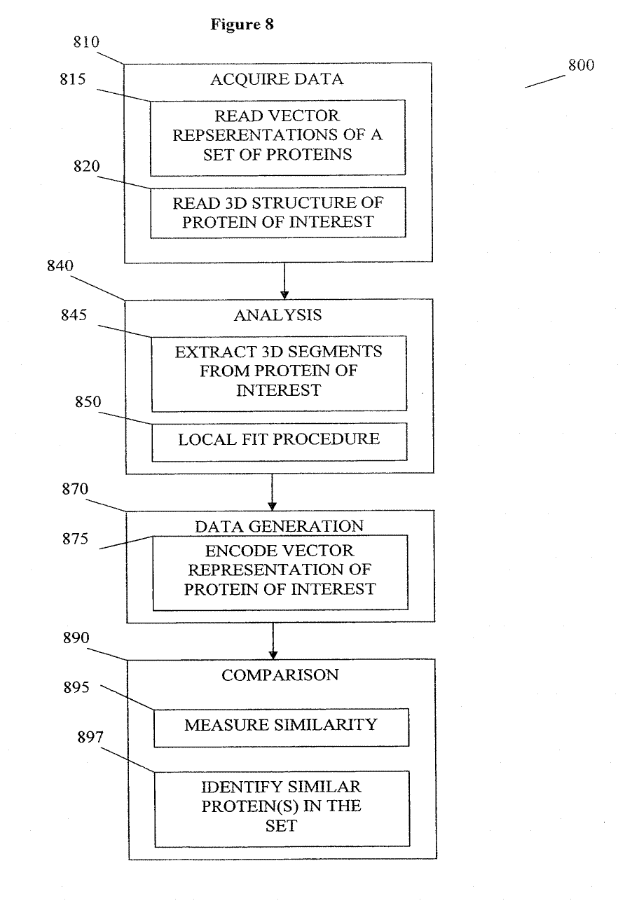

FIG. 8 shows a flow chart describing the retrieval of structurally similar proteins 800, in accordance with an embodiment of the invention. The method 800 includes acquiring the database representing the macromolecular structures of a plurality of proteins obtained in accordance with the method 700. The database typically maintains a plurality of arrays; the arrays represent a protein of the set of proteins. The arrays represent the proteins of the set, in the form of the bag-of-fragments representation.

The method 800 further includes obtaining a query protein (a protein of interest).

The query protein can be in the form (or format) of a representation maintaining its three dimensional structure or a portion thereof 820. The method also includes acquisition of a representation for the macromolecular structure of the query protein according to method 600 or the bag-of-fragment representation, as described herein.

A processor is configured and operable to measure similarity between the array (representing a protein of the set) previously obtained, and the array representing the query protein. The similarity measurement approximates structural similarity between the query protein and a protein in the set of proteins, thereby identifying structurally similar proteins.

The method 800 thus typically includes acquiring the database representing the macromolecular structures of a set of proteins 815 in accordance with method 600 (FIG. 6). The database maintains array/vector representations of the set of proteins stored therein in 815. These arrays represent the set of proteins in a bag-of-fragments representation. The method further includes the step or procedure of acquiring a query protein structure 820. A bag-of-fragment representation of the query protein is required for further processing and analysis 840.

Backbone segments of the protein of interest are obtained. For each of the backbone segments, a processor is utilized for determining the most geometrically similar protein fragment in said first representation, step 850. Optionally, procedure 850 is preceded by extraction of segments from the query protein (or representation thereof) 845. The segments can be backbone segments. In some embodiments, the protein of interest or a query protein can be sectioned (or segmented). By way of non-limiting example, such sectioning (or segmentation) of the query protein includes dividing the query protein to three dimensional structural backbone segments corresponding to a predetermined length, e.g., 5-20 amino acids. In some embodiment, the segments can overlap.

Data is generated 870, the data being the occurrence or observation frequencies of each most geometrically similar protein fragment in said query protein. This data being a bag-of-fragment representation of the query protein 875 which maintains information indicative of unordered and disjoint protein fragments therein. The data can be maintained in a vector or an array which can be generated or allocated to that end 875.

Determination of the most geometrically similar protein fragment can be performed by a local fit procedure 850 which for a geometric fragment includes geometric superimposition of a protein fragment vis-à-vis the compared backbone segments of the query protein.

The query protein can thus be processed to generate an array (or vector) which maintains a measurement of observation frequencies in the query protein of each the most geometrically similar protein fragment (as compared to backbone segments of the query protein).

The method 800 further includes utilizing a processor for measuring similarity 890, 895 between the array obtained in step 815 and the array obtained in step 820; the measurement approximates structural similarity between the query protein and a protein in the set, thereby identifying structurally similar proteins 897.

In some embodiments, the method 800 further includes outputting or displaying structurally similar proteins being identified.

In some embodiments, indexing the arrays is used to allow efficient access.

Thus, the present invention provides also a method for constructing an index for three dimensional macromolecular structures of proteins which includes the step of acquiring the database representing the macromolecular structures of a plurality of proteins in accordance with method 700 or other techniques disclosed herein. An array for each protein of the plurality of proteins is thus obtained. The array which maintains numerical as strings or binary based information can be indexed accordingly. Thus, the indexing method of the present invention includes further indexing the obtained arrays to permit efficient access to the array(s).

In one embodiment, therefore, layered index is used; the layered index can include basic partitioned index structure, and it may optionally maintain a balanced data structure. The person skilled in the art would appreciate that various methods and indexes can be used in this context to index the vector/array representation of the present invention.

The embodiments provided herein also relate to the techniques, methods and system of the present invention as disclosed herein. In some embodiments, therefore, the representation of the three dimensional structure of the protein backbone fragments includes a set of coordinates for the constituents of the protein backbone fragments in a three dimensional coordinate space.

In some embodiments, the representation of the three dimensional structure of the protein backbone fragments includes a set of coordinates of each amino acid in the protein backbone fragments; the coordinate are of a three dimensional coordinate space.

In specific embodiments, the representation of the three dimensional structure of the disjoint protein backbone fragments includes a set of coordinates of the Ca in each amino acid of the protein backbone fragments; the coordinate are of a three dimensional coordinate space.

In some embodiments, the representation of the three dimensional structure of protein backbone fragments includes a set of coordinates for the constituents of a protein geometric fragment associated with protein backbone fragments.

In some embodiments, the techniques and methods of the present invention comprising encoding an array which maintains bag-of-fragments representation being the observation frequencies in the protein of interest (or a query protein) of each of the most geometrically similar protein backbone fragment.

The observation frequencies data can be the number of occurrences of each the most geometrically similar protein backbone fragment in the query protein or the protein of interest. The observation frequencies can further be standardized or normalized for further processing.

The representation of the three dimensional structure of the backbone segments of the query protein can also include a set of coordinates for the constituents of the backbone segments in a three dimensional coordinate space.

In some embodiments, the representation of the three dimensional structure of the backbone segments includes a set of coordinates of each amino acid the backbone segment; the coordinate are of a three dimensional coordinate space.

In specific embodiments, the representation of the three dimensional structure of the backbone segments includes a set of coordinates of the Ca in each amino acid of the backbone segment; the coordinate are of a three dimensional coordinate space.

In some embodiments, the representation of the three dimensional structure of backbone segments includes a set of coordinates for the constituents of a backbone segment.

In some embodiments, the techniques and methods of the present invention comprising encoding an array which maintains bag-of-fragments representation being the observation frequencies in the protein of interest (or a query protein) of each of the most geometrically similar protein backbone fragment.

The observation frequencies data can be the number of occurrences of each the most geometrically similar protein backbone fragment in the query protein or the protein of interest. The observation frequencies can further be standardized or normalized for further processing.

The methods and techniques of the present invention can further include displaying the data of the protein of interest; the data being the bag-of-words representation, such as for example in the form of an array or vector maintaining the representation.

The array (or vector) can further be displayed or stored in a database.

The systems and techniques of the present invention utilize the three dimensional structure of protein fragments. The three dimensional structure of protein fragments can include three dimensional coordinates of each amino acid in the protein fragments. In some embodiments, the three dimensional structure of protein fragments are three dimensional coordinates of the Ca in each amino acid in the protein fragments.

As a non-limiting illustration, acquiring a representation of the three dimensional structure of protein fragments or a geometric fragments library can be performed using the structural information included in a protein database.

For convenience of explanation only the invention is described with reference to Protein Data Bank (PDB). Those vested in the art will readily appreciate that the invention is, likewise, applicable to other protein repositories or databases, either private or publically available.

The protein database can thus be selected from Protein Data Bank (PDB) and the like. In some embodiments, protein database can be a restricted set of proteins.

The protein database may be either public or private. Typically, the fold of the stored proteins in these databases is described by the atomic coordinates of the Cα atoms of the amino acids in the proteins. In addition, a protein database may comprise complete backbone coordinates information. This information can be transformed to the three dimensional protein backbone fragments. Such transformation typically includes determining protein fragment of a stored protein; and retrieving the associated (or corresponding) three dimensional structural information (e.g., backbone coordinates information) stored in the database; thereby arriving to three dimensional structure of protein fragments and representation thereof. Several methods can be used to obtain a geometric fragments library, for example as described by Kolodny et al [10]. In some embodiments, fragments from well-characterized protein structures are clustered and one representative fragment per cluster is taken to form the library.

The representation of the three dimensional structure of protein fragments (or the geometric fragments library) comprises overlapping or non-overlapping fragments of various lengths. In some embodiments, the fragments are at least of 5, 6, 7, 8, 9, 10, 11, 12 or 20 amino acids.

In some embodiments, the size of the library ranges between 20-600 fragments. In some embodiments, the library comprises at least 20, 40, 50, 70, 100, 200, 400, or 600 fragments.

The fragments library typically includes disjoint protein backbone fragments or a representation thereof. The person skilled in the art would appreciate that there are various techniques employed to represent these fragments in various data structures.

The fragment library can thereafter be used for the generation of the bag-of fragments representation of a protein. Thus, the three dimensional structure of protein fragments or a geometric fragments library or the fragments library can be utilized to represent a protein (e.g., protein of interest or a query protein). These protein fragments can be used as bin or buckets classifying segments of the protein of interest or the query protein. The latter can thus by divided to protein segments which can be subjected to a classification procedure which classifies the segments to a corresponding bin or bucket.

The classification of these segments can be performed by utilizing a ‘local-fit’ procedure according to which each segment in the query protein backbone (i.e., a protein the representation of which is sought) is approximated by the protein fragment that is most geometrically similar to it in the library (optionally in terms of RMSD). In some embodiments, the protein segments are classified to a bin or a bucket of a protein fragment where the geometric similarity between them is lower in terms of average local-fit RMSD than 1 A. Lower RMSD presents better approximation. In another embodiment, the geometric similarity measure can be modified by employing differential weight of the protein fragments, wherein at least two fragments in the library are weighted differently. In some embodiments, some fragments can be ignored. In other embodiments, the geometric similarity measurement is adapted to take account of fragments of different weight.

In some embodiments, a vector or array is generated for representing the number of times or occurrences a particular protein fragment is the best local approximation of a segment in the backbone of the protein being represented. The fragment is also referred to herein as the “most geometrically similar protein backbone fragment”.

The length of the vector/array is therefore typically of the size of the fragment library used. However, it may be shorter and represent only part of the library's fragments.

Therefore, in some embodiments, the vector/array maintains a histogram of the occurrences or observation frequencies of the three dimensional structures of the disjoint protein fragments.

The vector representing a protein can be defined by pᵢ=(pᵢ(1), pᵢ(2) . . . . , pᵢ(L)), where L is the size of the library and pᵢ(k) is the number of times fragment k is the best local approximation of a segment in the backbone of the protein.

The vector representing a protein can be a normalized vector defined as follows.

The vector representing a protein can be defined by pᵢ=(pᵢ(1), pᵢ(2) . . . . , pᵢ(L)), the normalized vector of which is \hat{p}ᵢ=pᵢ/|pᵢ|, where L is the size of the library and pᵢ(k) is the number of times fragment k is the best local approximation of a protein segment in the backbone of the protein.

In some embodiments, the vector representing the macromolecular structure of a protein as disclosed herein is weighted vector. In such a vector at least two elements are weighed differently

An array can also be generated to represent the data of any of the vector(s).

In some embodiments, a distance formula can be used to measure the similarity of the corresponding vectors or arrays. The distance formula can be selected from the group consisting of Euclidian distance formula, cosine distance formula, and Histogram Intersection distance formula.

In some embodiments, at least one of the following distance metrics between two vectors (pi, pⱼ) can be used to measure similarity between:

Cosine distance: dist(pᵢ,pⱼ)=1−\hat{p}ᵢ^{T}\hat{p}ⱼ

Histogram Intersection distance:

$$dist ( {p}_{i} , {p}_{j} ) = 1 - {\sum }_{j = 1}^{L} min \{ {p}_{i} ( k ) , {p}_{j} ( k ) \} / min \{ s ( {p}_{i} ) , s ( {p}_{j} ) \} ;$$

or

Euclidian (norm2) distance: dist(pᵢ,pⱼ)=∥pᵢ−pⱼ∥₂

where,

$$s ( {p}_{i} ) = {\sum }_{k = 1}^{L} {p}_{i} ( k )$$

Similarity of the corresponding vectors or arrays thus determined similarity of protein structures being represented by the vectors. By way of non-limiting example, where a pair of vector (pᵢ, pⱼ) maintain representations (e.g., bag-of-words representation) of a pair of proteins, (Pᵢ, Pⱼ, respectively), the similarity measure between the vectors is a measure of the structural similarity between the proteins being represented by the vectors (or arrays). The structural similarity can be similarity measure of the macromolecular structure.

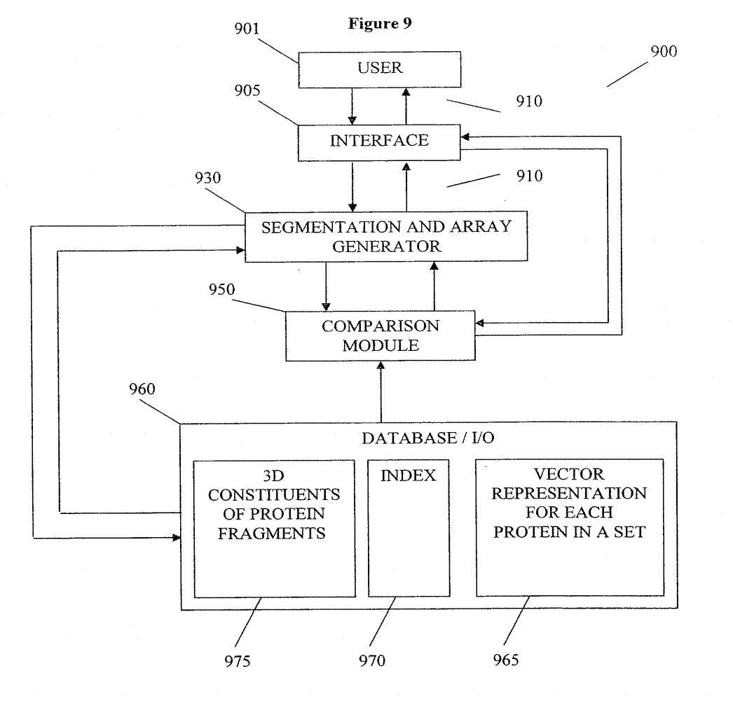

In another embodiment, the present invention is directed to a system configured for performing any of the above methods. Attention is now drawn to FIG. 9, showing an illustration of the architecture of a system 900, in accordance with an embodiment of the invention, for carrying out the above described methods and systems of the present invention. According to certain examples, system 900 comprise of main processing units includes a segmentation and array generator module 930 and a comparison module 950, and is associated with database 960 optionally maintained in appropriate data storage utility.

The system typically comprises an interface unit 905 configured and operable to accept and acquire an input protein such as a query protein. Optionally, the protein is of interest to the user 901. It should be noted that the system and/or the module may be configured in a single computer or otherwise distributed between multiple computers.

System 900 can thus be implemented in the context of a network. A network may be any appropriate computer network for example: the Internet, a local area network (LAN), wide area network (WAN), metropolitan area network (MAN) or a combination thereof. The connection to the network may be realized through any suitable connection or communication utility. The connection may be implemented by hardwire or wireless communication means via a client-server communication session.

The person skilled in the art would appreciate that one or more users/clients can be connected via network or otherwise to system 900. In other embodiments, system 900 may be fully or partially accessed outside of a context of a network or being directly accessed for example via a universal serial bus (USB) connection and a like.

Users or clients 901 may be, but are not limited to, personal computers, portable computers, PDAs, cellular phones or the like. Each user 901 may include a user interface 905 and possibly an application for sending and receiving web pages, such as a web browser application or web API, which may be utilized, for communicating with system 900.

The interface module 905 is configured to be responsive to search request initiated by user or clients. In one embodiment, the segmentation and array generator module 930 generates a representation of the macromolecular structure of the query protein fed by the user (user may in this context be natural or a machine such as a computer). The segmentation and array generator module 930 is configured and operable to perform method 600 to thereby generate a representation of the macromolecular structure of the query protein. This is typically perform is response to an actuation signal receive in response to a user query or request. Thus the present invention further provides a segmentation and array generator module configured and operable to perform method 600 to thereby generate a representation of the macromolecular structure of the query protein, i.e., a bag-of-words representation.

In accordance with the techniques of the present invention, the vector/array representation requires a library of the 3D structure of disjoint protein fragment 975. The array representation is communicated to the comparison module 950 which performs a similarity measurement between the array representation and those arrays/vectors stored in the database 965, thereby identifying structurally similar proteins ie. the output. The later can be communicated to the interface module 905 so that the user can inspect the output of the system. For the purpose of quick searching the arrays stored in the database 965 can be indexed by an indexing element 970.

The person skilled in the art would appreciate that a database can be any database known in the art capable of storing or retrieving the data of the present invention as disclosed herein, e.g., the vector or arrays. A database can be connected via network or otherwise to system 900. It can be a distributed database or a remote database. It can be a relational database or an OO database. Database or storage can encompass also semi-structured information storage and alike. In other embodiments, database or storage may be fully or partially accessed outside of a context of a network.

The present invention further provides a computer readable medium for storing computer instructions which cause a computer to perform any of the above methods. In particular, the present invention further provides a computer readable medium for storing computer instructions which cause a computer to perform at least any one method of methods 600, 700 or 800.

In some embodiments, the present invention provides a method for representing the structure of a protein, or a fragment thereof, comprising:

i) obtaining a library of geometric protein fragments;

ii) obtaining a query protein of interest;

iii) determining the number of occurrences of each geometric protein fragment in said query protein; and

iv) representing the number of occurrences as a numerical vector or an array;

wherein said numerical vector (or array) represents the structure of the protein.

Additionally, the present invention provides a method of searching for structurally similar proteins, comprising:

i) obtaining a representation of the structure of at least one protein, wherein said representation being in the form of a numerical vector representing the number of occurrences of each of a geometric protein fragment of a predetermined library;

ii) obtaining a query protein of interest;

iii) determining in said query protein the number of occurrences of each of said geometric protein fragments of the predetermined library;

iv) representing the number of occurrences obtained in step (iii) as a numerical vector;

v) measuring the similarity between the numerical vector obtained in step (i) and the numerical vector obtained in step (iii); and

vi) identifying at least one protein, or protein fragment, having a similarity higher than a predetermined level.

In other embodiments, the present invention provides a method for searching and retrieving a candidate set of near structural neighbors of a query protein from a protein database, comprising:

i) obtaining a representation of the structure of at least one protein or protein fragment of said protein database, wherein said schematic representation being in the form of a vector representing the number of occurrences of each of a geometric protein fragment of a predetermined library;

ii) obtaining a query protein of interest;

iii) determining in said query protein the number of occurrences of each of said geometric protein fragments of the predetermined library;

iv) representing the number of occurrences obtained in step (iii) as a vector;

v) measuring the similarity between the numerical vector obtained in step (i) and the numerical vector obtained in step (iii); and

vi) retrieving at least one protein, or protein fragment, having a similarity higher than a predetermined level.

whereby said at least one protein, or protein fragment, obtained in step (vi) being a candidate set of near structural neighbors of the query protein.

The present invention is also directed to a method for constructing a dictionary (or index) for three dimensional macromolecular structures of protein fragments, comprising:

(a) acquiring a first representation of three dimensional constituents of protein fragments;

(b) acquiring a second representation of three dimensional constituents of a set of proteins; the second representation comprises three dimensional constituents for each backbone segment in each protein of the set;

(c) for each of the backbone segment, utilizing a processor for determining the most geometrically similar fragment in the first representation; and

(d) storing the geometrically similar protein fragment as the key in the dictionary and the location of the backbone segment in the each protein as the associated value.

The present invention is also directed to a system for constructing a dictionary of three dimensional macromolecular structures of protein fragments, comprising:

i) storage for a first representation of three dimensional constituents of protein fragments;

ii) processor node configured to obtain a second representation of three dimensional constituents of a set of proteins; said second representation comprises three dimensional constituents for each backbone segment in each protein of the set;

iii) a comparison module configured to determine for each backbone segment the most geometrically similar protein fragment in said first representation;

iv) a storage module configured to store the representation of protein fragments as keys and an occurrence or location of the protein fragment in said each protein as an associated value;

wherein the comparison module determines the occurrence or location of the most geometrically similar protein fragment in each protein of the set; and the storage module stores the representation of protein fragments as keys and the occurrence or location of the protein fragment in said each protein as an associated value.

In another aspect, the present invention relates to a method of schematically representing the structure of a protein, or a fragment thereof, comprising:

i) obtaining a library of geometric protein fragments;

ii) obtaining a query protein of interest;

iii) determining the number of occurrences of each geometric protein fragment in said query protein; and

iv) representing the number of occurrences as a numerical vector;

wherein said numerical vector schematically represents the structure of the protein, or a fragment thereof.

In another aspect, the present invention relates to a method of searching for structurally similar proteins, comprising:

i) obtaining a schematic representation of the structure of at least one protein or protein fragment, wherein said schematic representation being in the form of a numerical vector representing the number of occurrences of each of a geometric protein fragment of a predetermined library;

ii) obtaining a query protein of interest;

iii) determining in said query protein the number of occurrences of each of said geometric protein fragments of the predetermined library;

iv) representing the number of occurrences obtained in step (iii) as a numerical vector;

v) measuring the similarity between the numerical vector obtained in step (i) and the numerical vector obtained in step (iii); and

vi) identifying at least one protein, or protein fragment, having a similarity higher than a predetermined level.

In another aspect, the present invention relates to a method for searching and retrieving a candidate set of near structural neighbors of a query protein from a protein database, comprising:

i) obtaining a schematic representation of the structure of at least one protein or protein fragment of said protein database, wherein said schematic representation being in the form of a numerical vector representing the number of occurrences of each of a geometric protein fragment of a predetermined library;

ii) obtaining a query protein of interest;

iii) determining in said query protein the number of occurrences of each of said geometric protein fragments of the predetermined library;

iv) representing the number of occurrences obtained in step (iii) as a numerical vector;

v) measuring the similarity between the numerical vector obtained in step (i) and the numerical vector obtained in step (iii); and

vi) retrieving at least one protein, or protein fragment, having a similarity higher than a predetermined level;

whereby said at least one protein, or protein fragment, obtained in step (vi) being a candidate set of near structural neighbors of the query protein.

Methods

Twenty four (24) geometric fragment libraries with 20-600 fragments of length 5-12 residues were constructed. The geometric fragments in the libraries comprised Ca traces of 200 protein structures that were accurately determined, and segmented them to fragments of a fixed length (5-12 residues). These fragments were clustered using k-means simulated annealing and take one representative from each cluster to form a library. The geometric fragment libraries therefore comprise representative fragments derived from these clusters.

Different measures to identify near structural neighbors in a dataset of 2928 protein domains [11] using ROC curve analysis was employed in the present study. A very stringent gold-standard was used: the near structural neighbors found by a best-of-all structural alignment method using SSAP[12], STRUCTAL, CE, SSM, DALI [13], and LSQMAN [14]. The performance of the method disclosed herein was measured to other filters: SGM, Zotenko et al., and PRIDE [3], to BLAST sequence alignment [15], and to the structural alignment methods STRUCTAL, CE, and SSM. In addition, it was statistically tested whether the suggested bag-of-words representation agrees with the CATH classification, i.e., whether bag-of-words representations of structures from different CATH categories are indeed different from each other in a statistically significant way.

The methods of the present invention outperform both other filter methods, and the sequence alignment method. More importantly, the methods of the present invention perform on a par with the computationally expensive structural alignment methods CE and STRUCTAL. The same ranking of methods using different threshold values for the definition of close structural neighbors was observed. Of course, comparing the histograms is orders of magnitudes faster than calculating the structural alignment of two structures. The present invention has the additional advantage that the PDB or another protein database can be searched even if only parts of the query are known: simply taking the union of the bag-of-words of these parts. Thus, it can be used as a fast and accurate filter for structure search in the entire PDB for example, and in structure search for protein structure prediction.

ROC Curve Analysis with Structural Alignments Gold Standard

A set of 2928 sequence-diverse CATH v.2.4 domains and their all-against-all structural alignments was used. The set was constructed for a previous comparison study of structural alignment methods [14] with one proviso. For the present purposes two structures (lpspAl, 1 pspB1) of length 7 residues were removed from the set because these are shorter than (some of) the geometric fragments in the subject fragment library.

All protein structures were structurally aligned to all other structures in the set using six structural alignment methods: SSAP, STRUCTAL, DALI, LSQMAN, CE, and SSM, and the alignment length and RMSD were recorded.

Our gold standard is the best-of-six method, where the best of the six alignments for every protein pair was selected in terms of the alignments' SAS with SAS=100*RMSD/(alignment length). It should be noted that in this set, the sequences of every pair of structures differ significantly (FAST E-value greater than 10⁻⁴).

A fragments bag-of-words description (or representation) of a protein is a vector; its length is the size of the library use. These libraries approximate proteins with the ‘local-fit’ procedure: each (overlapping) segment in the protein backbone is approximated by the fragment that is most similar to it in the library (optionally in terms of RMSD); optionally, the average local-fit RMSD is less than 1 A. Therefore, the vector can represents the number of times a particular fragment is the best local approximation of a segment in the backbone of the protein.

By way of non-limiting example, for a library of 100 geometric fragments a protein can be described by a vector having at least 100 parameters, each of these parameters account for particular geometric fragment.

Thus, denote the vector describing a protein by pᵢ=(pᵢ(1), pᵢ(2), . . . , Pᵢ(L)), the normalized vector by \hat{p}ᵢ=pᵢ/|pᵢ|, and by

$$s ( {p}_{i} ) = {\sum }_{k = 1}^{L} {p}_{i} ( k )$$

where L is the size of the library and pᵢ(k) is the number of times fragment k is the best local approximation of a segment in the backbone of the protein.

The following distance metrics between two vectors can be determined by any of the following:

(1) Cosine distance: dist(pᵢ, pⱼ)=1−\hat{p}ᵢ^{T}\hat{p}ⱼ
(2) Histogram Intersection distance:

$$dist ( {p}_{i} , {p}_{j} ) = 1 - {\sum }_{j = 1}^{L} min \{ {p}_{i} ( k ) , {p}_{j} ( k ) \} / min \{ s ( {p}_{i} ) , s ( {p}_{j} ) \}$$

(3) Euclidian (norm 2) distance: dist(pᵢ,pⱼ)=∥pᵢ−pⱼ∥₂

### Statistical Analysis

Raw Data: 8871 domains in the S35 family level in CATH version 3.2.0 domains (where the sequence identity between two domains is less than 35%) were used for statistical analysis. Since the classification at the C level is based simply on the secondary structure content of the structures, the focus was on the CA level, and the CAT level. To improve the statistical power of the tests, only CATH categories having at least 30 structures were used.

When partitioning the data set to categories at the CA level, there are 4 categories in the mainly-alpha class (totaling 2077 structures out of 2078); 9 categories in the mainly-beta class (totaling 1968 structures out of 2062); and 7 categories in the mixed alpha-beta class (totaling 4507 structures out of 4558). There was only one category in the few-secondary-structure class, and this class was therefore omitted from the analysis.

When partitioning the data set to categories at the CAT level, there are 12 categories in the mainly-alpha class (totaling 1013 structures); 13 categories in the mainly-beta class (totaling 1396 structures); and 22 categories in the mixed alpha-beta class (totaling 2681 structures). Overall, the analysis involved m=8552 proteins when testing at the CA level, and m=5090 when testing at the CAT level.

Data in a Matrix Form: Consider a fixed library of N fragments; a protein is then described by a count vector of length N. The data is initially summarized in an N×m matrix A, whose (i,j)-th entry is the number of times fragment j appeared in protein i. The matrix A is partitioned row-wise into K blocks, corresponding to CATH's protein categories (either at the CA level or the CAT level). Denote by m·ₖ the number of rows of the kth block.

Omnibus Test: a statistic s was constructed that captures the overall dissimilarity between vectors belonging to different categories; large values of s support rejecting the null hypothesis, according to which the partition into blocks carries no information with respect to the classification. Firstly, A's columns were standardized by dividing each column by its standard deviation. Let A^{k} be the mₖ×N sub-matrix of (the standardized) A, corresponding to the kth block, and let Ā^{k} be the N-vector whose entries are the means of the columns of A^{k}. For two distinct blocks, k and l, let Dₖₗ=max|Ā^{k}−Ā^{l}|, where the maximum is taken over the N differences between the entries of the two vectors. The omnibus test statistic is

$$s = {max}_{1 \leq k \neq l \leq K} {D}_{kl} .$$

To determine the p-value: P(S≧s) is calculated, where S is a similarly computed score under a random permutation of A's rows. Since the number of permutations is too large, estimating the p-value is performed in a Monte Carlo fashion, by drawing 1000 random permutations of A's rows, and observing the proportion of the permutations achieving a statistic higher than s. The omnibus test results were all significant, for comparisons both at the CA and CAT levels, for all 24 libraries, and for each of the three CATH classes (p<0.001 in all cases).

Post Hoc Analysis: Once the omnibus test results were found significant, the data was tested for a more stringent alternative hypothesis, according to which any two blocks are different from each other (rather than testing for the existence of at least one pair of different blocks, as the omnibus test does). In the post-hoc analysis, the above test was performed separately for all d=K(K−1)/2 pairs of blocks. When comparing blocks k and l, the matrix A in the procedure described above is of dimension (mₖ+mₗ)×N, and as only two blocks are considered, the test statistic (of this comparison) reduces to s=Dₖₗ The result of the test is a d-vector of p-values, corresponding to the d pairwise comparisons.

### Data Set of NMR Assemblies

The data set of NMR structures is the one constructed in the PRIDE study [3]. There are four assemblies that were replaced by newer ones in the PDB, and in our set (1bqv, 1bmy, 1e01, and 1dlx). All structure pairs within an NMR assembly were considered. Since these pairs are of the same protein, the alignment is known and can easily calculate the RMSD. There are 54,465 pairs, 43,246 of them with an RMSD≦4 A.

### Results

### ROC Curves Analysis to Compare the Performance of Filter Methods

Accuracy of different structural retrieval methods by how well they identify the set of near structural neighbors of a query protein structure in a database of diverse structures was measured. Databases of 2928 protein structures of non-redundant sequences were considered. These were queried using each of its structures. The gold-standard answer includes neighbors found by a best-of-six structural alignment method (using SSAP, STRUCTAL, DALI, LSQMAN, CE, and SSM); finding these neighbors is a very expensive computation and was done in a previous study [11]. Namely, the near structural neighbors of the query are structures that were aligned to it with an SAS value smaller than threshold T (for T=2 A, 3.5 A, and 5 A). The AUC (area under curve) of a ROC curve was used to measure how well each method identifies the near structural neighbors of a query [16], and average the AUC values over all queries. Recall that a higher AUC is better: a perfect imitator of the gold standard will have an AUC of 1 and a random measure will have an AUC of 0.5.

Table 1a lists for 24 fragment libraries (with fragment lengths 5-12 residues, and sizes ranging from 20-600) the average AUC of the ROC curves with respect to three gold-standards (defined by T=2 A, 3.5 A, and 5 A). Three bag-of-words/histogram similarity measures were used as follows: cosine distance, Histogram intersection, and Euclidian (norm 2) distance; the supplementary material includes results for other (less successful) similarity measures.

For comparison, Table 1b lists the average AUC of the ROC curves for alternative, existing methods for identifying similar proteins. Three (3) types of methods were performed: (1) a sequence-based similarity measure: BLAST's E-value [59]. (2) Filter methods: PRIDE [31], SGM [33], and the method by Zotenko et al. [39]. (3) Structure alignment methods: STRUCTAL, CE, and SSM; alignments were sorted by their SAS scores and for STRUCTAL and CE by their native scores as well.

TABLE 1b

| | | | | | | | | | Sequence |
|---|---|---|---|---|---|---|---|---|---|
| | SSM | Structal | Structal | CE | CE | | | | similarity |
| | using | using | using | using | using | | | | using |
| | SAS | Native | SAS | Native | SAS | Zotenko | | | BLAST E- |
| | score | score | score | score | score | et al. | PRIDE | SGM | value |
| 2A | 0.94 | 0.87 | 0.90 | 0.90 | 0.84 | 0.78 | 0.72 | 0.86 | 0.76 |
| 3.5A | 0.90 | 0.77 | 0.81 | 0.79 | 0.72 | 0.64 | 0.54 | 0.71 | 0.57 |
| 5A | 0.89 | 0.83 | 0.84 | 0.74 | 0.75 | 0.66 | 0.51 | 0.68 | 0.50 |

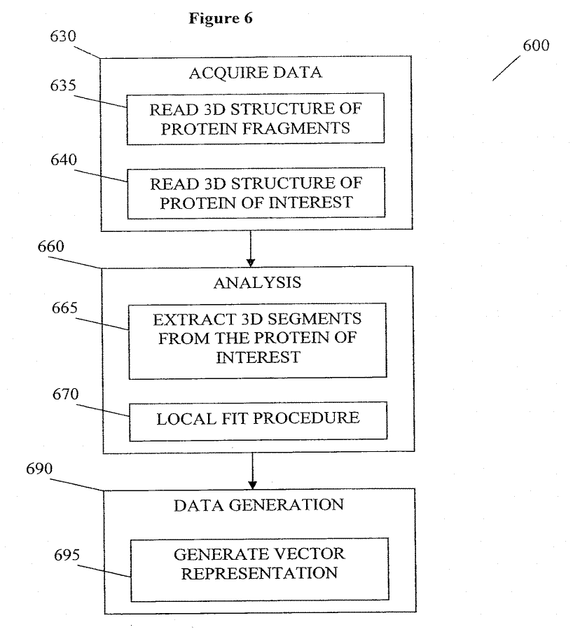

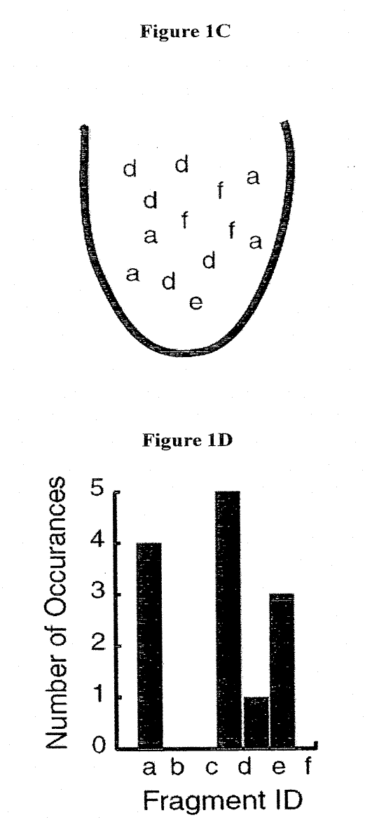

FIGS. 2A-2C plot the average AUC of the ROC curves for different libraries, as a function of the library size. Libraries with fragments were colored as follows: length 6 residues (blue), 7 (cyan), 9 (green), 10 (yellow), 11 (magenta), and 12 residues (red). For each library, the results were plotted using three bag-of-words/histogram similarity measures: diamonds for histogram intersection, circles for Euclidian (norm 2) distance, and the plus sign for cosine distance. FIGS. 3A-3C compare the average AUC of the ROC curves of our best library with values of methods developed by other scholars: the sequence-based similarity measure with a fine dashed black line, the filter methods with dashed black lines, and the structure alignment methods with solid black lines.

The ranking of the performance of different methods is generally independent of the SAS score threshold that defines the gold standard. Here, three thresholds which were used correspond to three definitions of structural neighbors: the strictest includes only structures that were aligned with an SAS score lower than 2 A (FIG. 2C), the most lax definition includes structures that were aligned with an SAS score lower than 5 A (FIG. 2A). The methods perform better (i.e., achieve higher average AUC values) when the definition of structural neighbors is more strict, and less well when the definition includes more geometrically distant structures. Note that structures with a structural alignment SAS score lower than 5 A are still meaningful structural. The best results were demonstrated using a library of 400 fragments, each 11 residues long, and using the cosine distance; the average AUCs are 0.89, 0.77, and 0.75 when the gold standard defines structural neighbors using SAS score thresholds of 2 A, 3.5 A, and 5 A respectively. It is best to compare two fragments bag-of-words with the cosine distance. From comparing libraries of fixed sizes (100, 200, or 400 fragments), when using cosine distance, it appears that libraries of longer fragments perform better; when using the histogram intersection or the Euclidean distances, the length of the fragment does not influence the results.

The ranking of the filter methods (from most to least successful) is: (1) fragments bag-of-words representation (namely the one based on a library of 400 fragments of length 11 residues and the cosine distance) (2) SGM (3) the method by Zotenko et al., and (4) PRIDE, which performs similarly to the sequence-based method. Among the structural alignment methods, the most successful is SSM, followed by STRUCTAL and CE.

The accuracy of the filter methods is lower or equal to that of the structural alignment methods and higher (or equal to) the sequence-based method.

FIGS. 3A-3C demonstrate that the best filter method, i.e., our fragments bag-of-words (BagFrag) representation performs on a par with CE and STRUCTAL, two computationally-expensive and highly-trusted structural alignment methods. Using the gold-standard defined by the 5 A SAS threshold, our filter method has an average AUC of 0.75, which is similar to CE's 0.74 using the native score, and 0.75 using SAS score. For the gold-standard defined by the 3.5 A threshold, our best filter method has an average AUC of 0.77 which is similar to STRUCTAL's 0.77 using its native score and CE's 0.72 using SAS score. For the gold standard defined by the 2 A threshold, our best filter method average AUC is 0.89 which is similar to STRUCTAL's 0.87 using its native score, and CE's 0.84 using SAS score; it is also very similar to the 0.90 achieved by STRUCTAL using SAS score and CE using native score.

### Categories of CATH Proteins have Bag-of-Words Descriptions that are Different from Each Other in a Statistically Significant Way

Statistical test was performed to answer whether the fragment bag-of-words representation of proteins agrees with the CATH classification, both at the CA level and at the CAT level. Omnibus test was used and also a post-hoc analysis was performed. The post-hoc analysis involves a large number of pairwise comparisons, inflated Type I error rate in two ways was controlled: using the Bonferroni correction [17], and using the False Discovery Rate (FDR) approach [18]. It was demonstrated that bag-of-words representation classifies a protein according to CATH classification, both at the CA level and at the CAT level.

CATH categories with 30 proteins or more were considered to improve the statistical power of the tests. This restricts the data set to 8552 proteins (out of the original 8871) when testing for classification at the CA level, and to 5090 proteins when testing at the CAT level. The tests were run separately on CATH's mainly-α, mainly-β, and mixed α+β classes. The data is multivariate, as each data point (a protein) consists of N observations, yet it certainly cannot be assumed to be normally distributed. Thus, a non-parametric permutation test was utilized, adapted from Good [19].

For the omnibus test, a statistic s was constructed such that it captures the overall dissimilarity between vectors belonging to different CATH categories (see the Methods section for details above). Large values of s support rejecting the null hypothesis, according to which the partition into blocks carries no information with respect to the CATH classification. The omnibus test results were all significant, for comparison both at the CA level and at the CAT level, for all 24 libraries, and for each of the three CATH classes (p-value<0.001 in all cases).

In the post-hoc analysis, the data was tested for a more stringent alternative hypothesis, according to which any two blocks are different from each other (rather than testing for the existence of at least one pair of different blocks, as the omnibus test does). To do this, the abovementioned test was performed separately for all d=K(K−1)/2 pairs of categories, where K is the number of categories of interest.

The most conservative way of controlling for the multiple comparisons involved in this procedure is to use the Bonferroni correction, and to declare as significant only the comparisons in which the p-value is below α/d, where α is the chosen significance level; the subject statistical test use the standard α=0.05 value.

Table 2 summarizes the results of the post-hoc analysis under the Bonferroni correction, across the 24 libraries. For example, there are 12 mainly-α. CATH categories at the CAT level, and therefore 12*11/2=66 category pairs. Out of the 66 corresponding comparisons, 61 were found significant at the 0.05/66=0.000757 significance level across all 24 libraries, hence the fraction 61/66 at the table's first cell in the second row. The parenthesized figures in the table are the fraction of significant pairwise comparisons for the library of 400 fragments of length 11. The complete test results, listed separately for each library, are available as supplementary material.

An alternative approach to tackle the multiple comparisons problem in the post-hoc analysis is the False Discovery Rate (FDR) approach; using this approach, one finds which pairwise comparisons can be declared significant, while controlling the average fraction of the wrongly declared pairs at some fixed, chosen level. For details, see ref [62]. Table 2 (right) summarizes the results of the FDR post-hoc analysis; the fraction of comparisons declared significant, averaged across the 24 libraries and under an FDR of 0.05, is reported. The parenthesized figures are the fraction of the comparisons declared significant for the library of 400 fragments of length 11.

The very low p-values of the omnibus tests and the values reported in Table 2 (all being very close to 1) strongly support the conclusion that the fragment bag-of-words representation indeed agrees with the CATH classification, both at the CA and CAT level.

TABLE 2

| | Analysis using | | | | | |
|---|---|---|---|---|---|---|
| | Bonferroni correction | | | | | |
| | | | Mixed | Analysis using FDR | | |
| | Mainly | Mainly | α + | Mainly | Mainly | Mixed α + |
| | α | β | β | α | β | β |
| CA | 6/6 | 31/36 | 21/21 | 6/6 | 36/36 | 21/21 |
| | (6/6) | (35/36) | (21/21) | (6/6) | (36/36) | (21/21) |
| CAT | 61/66 | 76/78 | 206/231 | 65.5/66 | 78/78 | 230.2/231 |
| | (65/66) | (78/78) | (225/231) | (65/66) | (78/78) | (231/231) |

### Comparison of Fragments Bag-of-Words Similarity Measure to RMSD on Structure Pairs within NMR Assemblies

Statistical test was performed in order to examine whether the fragment bag-of-words representation of proteins identifies similarity between structures that are only locally similar, i.e., have highly similar substructures that are connected differently. The ability to identify such local similarity can be utilized in detecting similarity to a partially characterized structure, as typically needed in structure prediction.

The properties of the fragments bag-of-words similarity measures were further analyzed by considering the similarity of pairs of structures within NMR assemblies—a collection of structures that are consistent with the experimental constraints; these typically differ only at several flexible points along the backbone, and are thus locally similar.

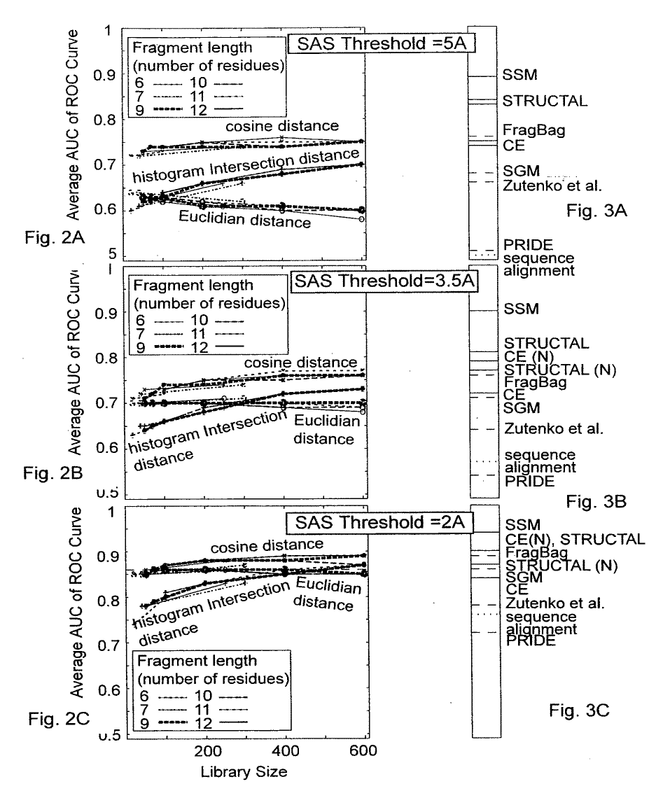

Library of 400 fragments of length 11 residues was used. Data set of 230 NMR assemblies was used as was constructed in the PRIDE study [3] and includes 43,246 pairs with RMSD≦4 A. FIGS. 4A-4C plot the geometric fragments bag-of-words (cosine, Euclidian, and Histogram Intersection) distance vs. the RMSD; the number of occurrences in each combination of bag-of-words and RMS distances is color-coded.

The bag-of-words representation identifies similarity between locally similar structures. The vast majority of pairs are identified as very similar by the bag-of-words representation: 91% have cosine distance below 0.35, Histogram intersection distance below 0.5, and 96% Euclidian distance below 10.

For comparison, Table 3 lists the average distances and standard deviations of the fragments bag-of-words distances of sets of structure pairs at different levels of structural similarity; library of 400 fragments of length 11 residues was used. The most similar structure pairs are those within NMR assemblies: only the highly similar (RMSD≦4 A) were considered, and all pairs in the abovementioned set. Pairs of structures in the set of 2928 CATH domains were considered such that they have the same classification at different levels of the hierarchy: same CATH, same CAT, same CA, same C, and pairs that have different C classifications.

As expected, the average distance is lowest within the highly similar sets, and grows as the sets grow more structurally diverse; this is true in all three measures of similarity. The results are similar when representing structures using other fragment libraries (data not shown).

Note that the average distance values of structure pairs with the same CATH classification is higher than the threshold value mentioned above for the similarity of structure pairs within NMR assemblies.

TABLE 3

| | Histogram | | |
|---|---|---|---|
| 400 fragments of length | Intersection | Euclidian | Cosine |
| 11 library | distance | distance | distance |
| within NMR assembly | 0.25 ± 0.13 | 5.46 ± 2.46 | 0.17 ± 0.13 |
| (RMSD ≦ 4 A) | | | |
| within NMR assembly | 0.29 ± 0.15 | 5.96 ± 2.66 | 0.20 ± 0.16 |
| Same CATH classification | 0.52 ± 0.11 | 17.32 ± 8.33 | 0.34 ± 0.19 |
| Same CAT classification | 0.54 ± 0.11 | 21.14 ± 8.95 | 0.35 ± 0.19 |
| Same CA classification | 0.56 ± 0.15 | 23.75 ± 15.72 | 0.39 ± 0.24 |
| Same C classification | 0.56 ± 0.14 | 26.73 ± 16.34 | 0.46 ± 0.24 |
| Different C classification | 0.68 ± 0.18 | 30.56 ± 20.83 | 0.65 ± 0.27 |

### Performance and Advantages

Given a protein structure query, the methods and system of the present invention quickly identify candidates for its near structural neighbors using a geometric fragments bag-of-words representation of protein structure; the present method does not sacrifice accuracy for performance: it performs on a par with the computationally expensive and highly trusted structural alignment methods.

In particular, it can be observed that a fragments library of 400 fragments of length 11 finds near structural neighbor candidate sets that are comparable in accuracy to those found by CE and STRUCTAL. Recall that CE and STRUCTAL are among the best structural alignment methods [14].

In general, and as expected, candidate sets for near structural neighbors are best identified by structural alignment methods, followed by filter methods; sequence alignment is the worst performer. The results achieved by the systems and method of the present invention are robust: similar ranking of methods using different definitions for the near structural neighbors of a protein.

An additional feature of the bag-of words representation is that one can store the vectors representing PDB proteins (optionally all PDB proteins) in an inverted index—a data structure designed for fast retrieval of neighbors. Thus, a bag-of words representation can be generated for each protein, e.g., PDB protein. The vector can be stored in an index or an inverted index for fast retrieval. Since a filter method needs to identify near structural neighbors, a gold standard of near structural neighbors should be used. Gold standard of the present invention was constructed using a very expensive computation of best-of-six structural alignment method. Herein, neighbors were found using the expensive computation of a best-of-six structural aligner. Namely, a structure was identified as a neighbor if any of the six methods finds in both proteins a sizable substructure that can be superimposed with a low RMSD. Such a neighbor was selected regardless of its CATH classification, and could well belong to a category other than that of the query protein.

This is essential since there are many cross-fold similarities to identify. Furthermore, if a classification was relied upon and marked proteins of similar structures as non-neighbors, the ROC curve analysis would have effectively penalized filter methods that correctly identify these similar structures.

On the other hand, the abstraction offered by the CATH classification is a ground truth that cannot be ignored. It should be expected therefore that bag-of-words/histogram representation of proteins belonging to the same CATH category (either at the CA or the CAT level) to be similar to each other. Indeed, extensive statistical testing confirms this hypothesis.

In order to avoid trivial cases where protein similarity is due to mere sequence similarity, data sets of non-redundant sequences was used. Specifically, in the data set for identifying near structural neighbors candidate sets, a threshold of 10⁻² FASTA sequence alignment E-value was used; in the data set for the statistical analysis of the differences among CATH categories the sequence similarity threshold is 35%. Notice that when there are only few near structural neighbors, even a method that merely ranks the query as the most similar to itself does better than random (AUC of 0.5), even though this is clearly a trivial thing to do. The average AUC of the ROC curves also depends on the characteristics of the data set. Thus, the average AUC of the ROC curves of the sequence alignment method acts as a lower bound; it indicates how difficult is the task of identifying near structural neighbor candidates in the data set. It is harder to identify candidate sets for larger SAS thresholds, and that for the threshold of 5 A, the sequence alignment lower bound is the same as a random method.

The fragments bag-of-words similarity measure has an additional important advantage: it can search for structures in the PDB even with a query structure that is only partially characterized. In the context of protein structure prediction, this type of search is very useful. Often, a structure prediction method predicts the structure of parts of a protein, but does not know how these parts combine into a complete structure. In these cases, identifying structures in the PDB that have these parts may hint at the way these parts should be combined. In the fragments bag-of-words representation of proteins of the present invention, missing information has a minor impact. The bag-of-words representation of proteins of the present invention completely ignores the spatial arrangement, order or location of the geometric fragments. That is, the bag-of-words that is the union of the bags-of-words of the parts differs from the exact representation only at the few connecting regions. Similarly, two structures that are flexible variants of each other (i.e., differ only at a hinge point) will have very similar representations. Indeed, the fragments bag-of-words similarity measures identify structures within NMR assemblies as very similar.

The bag-of-words representation of a protein of the present invention as disclosed and claimed herein completely ignores and does not involve the spatial arrangement, order or location of the geometric fragments in the proteins. Therefore, the methods and systems of the present invention do not require nor necessitate alignment procedures of geometric fragments in order to retrieve or search for structurally similar proteins. Nor do they require alignment procedures for generating a representation for the macromolecular structure of a protein (i.e., generating a bag-of-words representation of a protein).

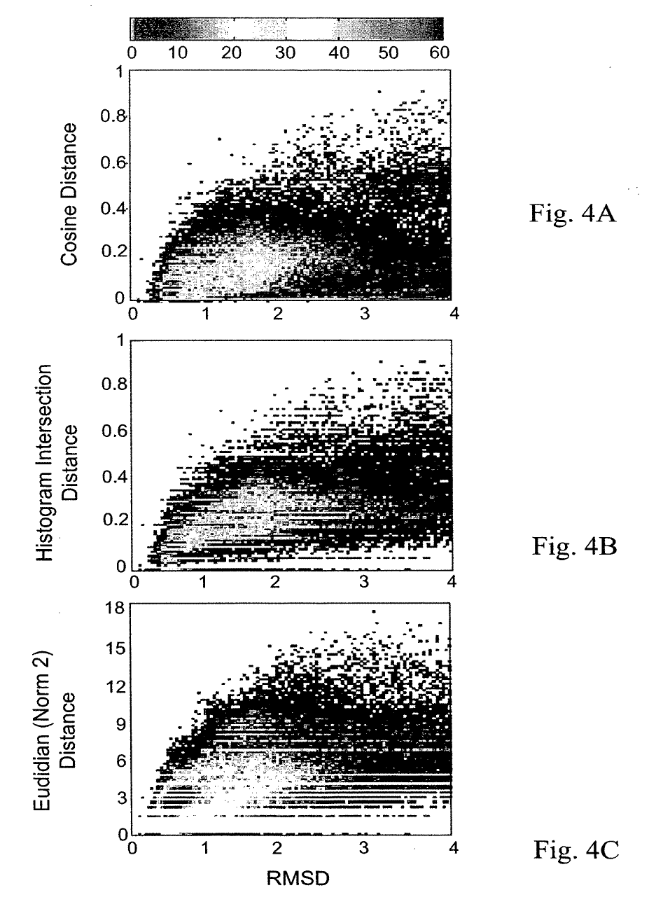

Techniques other than the bag-of-words representation disclosed herein, where to representation of proteins relies on the internal distance matrix of a protein are sensitive to missing information such as relative orientation of protein parts. FIG. 5 demonstrates an example of a protein with two known domains of approximately equal size, with unknown relative orientation; the known regions in the internal distance matrix are marked in gray, and the unknown in white. In a frequency vector of matrix patches half of the values comprising the vector will be missing (i.e., are from the white regions), rendering the identification of a neighbor structure very difficult. Similarly, the internal distance matrices of two structures that vary at a hinge point will differ at the regions corresponding to the distances between the two domains (the white regions), resulting in significantly different frequency vectors.

The present invention allows fast and accurate structural comparison of proteins while relatively maintaining low computation time vis-a-vis available structural alignment based methods, even where the size of the local motif alphabet or geometric fragment libraries used are large as much as 20, 40, 100, 100, 200, 250, 300, 400 and 600 elements. The present invention exhibits superior performance in comparison to available methods as demonstrated herein. Moreover, the present invention provides for structural comparison of proteins without requirement of alignment of the proteins and protein structure, construction of internal distance matrices, or analysis of the spatial layout of local structural or geometric motifs.

What is claimed is:

1. A system for searching structurally similar proteins, comprising:
a first storage that maintains a library of representations of three dimensional structures of disjoint protein backbone fragments;
a second storage that maintains macromolecular structures of a plurality of proteins, each protein structure of the plurality of proteins represented by a respective first array, wherein each first array records observation frequencies of the disjoint protein backbone fragments in each respective protein of the plurality of proteins; and
a processor communicatively coupled to the first storage and second storage, wherein the processor:
obtains a three dimensional structure of a query protein,
transforms the three dimensional structure of the query protein to a second array that records observation frequencies of the disjoint protein backbone fragments in the query protein by comparison to the library of representations of three dimensional structures of disjoint protein backbone fragments,
determines similarity between each of the first arrays and the second array, thereby identifying proteins in the plurality of proteins that are structurally similar to the query protein.

2. The system of claim 1, wherein the processor communicates an output of the proteins in the plurality of proteins that are structurally similar to the query protein to a user interface.

3. The system of claim 1, wherein the three dimensional structure of the protein fragments are three dimensional coordinates of the protein fragments.

4. The system of claim 1, wherein the representation of the three dimensional structure of said disjoint protein backbone fragments comprises a set of coordinates of each amino acid in the protein backbone fragments in a three dimensional coordinate space.

5. The system of claim 1, wherein the representation of the three dimensional structure of said disjoint protein backbone fragments comprises a set of coordinates of the Ca in each amino acid in the protein backbone fragments in a three dimensional coordinate space.

6. The system of claim 1, wherein the protein backbone fragments are at least 5 amino acids.

7. The system of claim 1, the system further comprising a database and wherein the first arrays are indexed and maintained on the database, and the processor obtains the first arrays from the database.

8. The system of claim 1, wherein the processor communicates an output of the first arrays of the proteins in the plurality of proteins that are structurally similar to the query protein to a user interface.

9. The system of claim 1, wherein the processor communicates the three dimensional structures of the proteins in the plurality of proteins that are structurally similar to the query protein to a user interface.

10. A method for generating a representation for the macromolecular structure of a protein of interest, comprising:
i) acquiring a first representation of a collection of predetermined, three dimensional structure of disjoint protein backbone fragments
ii) acquiring a second representation, wherein said second representation comprises the three dimensional structure of a plurality of backbone segments in said protein of interest;
iii) utilizing a processor to determine the most geometrically similar protein backbone fragment in said first representation for each of said backbone segments; and
iv) generating data being the observation frequencies of each most geometrically similar protein backbone fragment in said protein of interest; said data represents the macromolecular structure of the protein of interest.

11. A method for generating a database representing macromolecular structures of a plurality of proteins, comprising:
i) acquiring a first representation of a collection of predetermined, three dimensional structure of disjoint protein backbone fragments
ii) acquiring a second representation wherein said second representation comprises the three dimensional structure of a plurality of backbone segments in each protein of said plurality of proteins;
iii) utilizing a processor to determine the most geometrically similar backbone fragment in said first representation for each of said backbone segments; and
iv) generating data being the observation frequencies of each said most geometrically similar protein backbone fragment in each protein of said plurality of proteins;
v) for each protein in said plurality of proteins, encoding an array maintaining said data; and optionally storing the array in said database.

12. A method for retrieval of structurally similar proteins, comprising:
i) acquiring the database representing the macromolecular structures of a plurality of proteins obtained in accordance with claim 11; thereby obtaining a plurality of arrays, each representing a protein of said plurality of proteins;
ii) obtaining a query protein of interest;
iii) acquiring a representation for the macromolecular structure of said protein of interest by
a) acquiring a first representation of a collection of predetermined, three dimensional structure of disjoint protein backbone fragments
b) acquiring a second representation, wherein said second representation comprises the three dimensional structure of a plurality of backbone segments in said protein of interest;
c) utilizing a processor to determine the most geometrically similar protein backbone fragment in said first representation for each of said backbone segments; and
d) generating data being the observation frequencies of each most geometrically similar protein backbone fragment in said protein of interest; said data represents the macromolecular structure of the protein of interest,
thereby obtaining an array having data being the observation frequencies in the protein of interest of each said most geometrically similar disjoint protein backbone fragment;
iv) utilizing a processor for measuring similarity between the array obtained in step (iii) and the arrays obtained in step (i); wherein the measurement approximates structural similarity between the protein of interest and a protein in said plurality of proteins, thereby identifying structurally similar proteins.

13. A method for constructing an index for three dimensional macromolecular structures of proteins, comprising:
i) acquiring the database representing the macromolecular structures of a plurality of proteins of claim 11, thereby acquiring an array for each protein of said plurality of proteins;
ii) indexing the arrays to allow efficient access to said array.

14. The method of claim 11, wherein the representation of the three dimensional structure of said protein backbone fragments comprises a set of coordinates selected from the group consisting of:
i) a set of coordinates for the constituents of the protein backbone fragments in a three dimensional coordinate space;
ii) a set of coordinates of each amino acid in the protein backbone fragments in a three dimensional coordinate space;
iii) a set of coordinates of the Ca in each amino acid in the protein backbone fragments in a three dimensional coordinate space; and
iv) a set of coordinates for the constituents of a protein geometric fragment associated with protein backbone fragments.

15. The method of claim 10 further comprising encoding an array which maintains data being the observation frequencies of each of said most geometrically similar protein backbone fragment in said protein of interest.

16. The method of claim 15 wherein said observation frequencies data is the number of occurrences of each said most geometrically similar protein backbone fragment in said protein of interest.

17. The method of claim 15 wherein the observation frequencies are standardized.

18. The method of claim 10, further comprising displaying the data of the protein of interest.

19. The method of claim 11, further comprising displaying the array.

20. The method of claim 12, further comprising displaying structurally similar proteins.
